(19) United States
(12) Patent Application Publication
(10) Pub. No.: US 2015/0192700 A1
(43) Pub. Date: Jul. 9, 2015

(54) COMPOSITION FOR POLARIZING FILM, POLARIZING FILM AND DISPLAY DEVICE

(71) Applicant: SAMSUNG ELECTRONICS CO., LTD., Suwon-si (KR)

(72) Inventors: Jong Hoon WON, Yongin-si (KR); Beom Seok KIM, Seoul (KR); Seong-Jun YOON, Seoul (KR); Myung Sup JUNG, Seongnam-si (KR)

(21) Appl. No.: 14/591,526

(22) Filed: Jan. 7, 2015

(30) Foreign Application Priority Data
Jan. 8, 2014 (KR) 10-2014-0002488

(51) Int. Cl. G02B 1/08; G02B 5/20; G02B 5/30

(52) U.S. Cl. CPC G02B 1/08; G02B 5/3025; G02B 5/208

(57) ABSTRACT

A composition for a polarizing film including a polymer, a first dichroic dye having a maximum absorption wavelength (λₘₐₓ) of about 400 nm to about 780 nm, and an ultraviolet (UV) absorber or a second dichroic dye having a maximum absorption wavelength (λₘₐₓ) of about less than 400 nm.

### CROSS-REFERENCE TO RELATED APPLICATION

This application claims priority to Korean Patent Application No. 10-2014-0002488 filed on Jan. 8, 2014, and all the benefits accruing therefrom under 35 U.S.C. §119, the content of which is incorporated herein in its entirety by reference.

### BACKGROUND

1. Field

A composition for a polarizing film, a polarizing film, and a display device are disclosed.

2. Description of the Related Art

A display device such as a liquid crystal display (LCD) and an organic light emitting diode (OLED) device include a polarizing plate attached to the outside of a display panel. The polarizing plate only transmits light of a specific wavelength and absorbs or reflects other light, so it may control the direction of incident light in the display panel or light emitted from the display panel.

The polarizing plate generally includes a polarizer and a protective layer for protecting the polarizer. The polarizer may include, for example, iodine or dichroic dye adsorbed and arranged on polyvinyl alcohol (PVA), and the protective layer may include, for example, triacetyl cellulose (TAC).

However, the manufacture of the polarizing plate including the polarizer and the protective layer not only involves a complicated process and high production costs, but also produces a thick polarizing plate which leads to an increased thickness of a display device.

Accordingly, a polarizing film that does not require a protective layer has been researched. The polarizing film having no separate protective layer is suitable for realizing a thin display device.

However, because the polarizing film has no protective layer and is thin, it may pass ultraviolet (UV) rays in a process requiring ultraviolet (UV) curing. Herein, a display panel exposed to the ultraviolet (UV) rays may be damaged, and particularly, the ultraviolet (UV) rays may deteriorate display characteristics and life-span in an organic light emitting diode (OLED) display using an organic material.

Accordingly, there remains a need to reduce damage to the polarization film caused by the ultraviolet (UV) rays without loss in its polarization characteristics.

### SUMMARY

An embodiment provides a composition for a polarizing film having no influence on polarization characteristics but that decreases damage caused by ultraviolet (UV) rays.

Another embodiment provides a polarizing film having no influence on polarization characteristics but that decreases damage caused by ultraviolet (UV) rays.

Another embodiment provides a display device including the polarizing film.

According to an embodiment, a composition for a polarizing film includes

a polymer,

a first dichroic dye having a maximum absorption wavelength (λₘₐₓ) of about 400 nanometers to about 780 nanometers, and

an ultraviolet (UV) absorber or a second dichroic dye having a maximum absorption wavelength (λₘₐₓ) of about less than 400 nanometers.

The ultraviolet (UV) absorber may have a melting point of about 95 to about 300° C.

The ultraviolet (UV) absorber may include a benzotriazole compound, a triazine compound, a benzoate compound, or a combination thereof.

An amount of the ultraviolet (UV) absorber may be about 0.1 to about 5 parts by weight based on 100 parts by weight of the polymer.

The second dichroic dye may have a maximum absorption wavelength (λₘₐₓ) of about 360 nanometers to about 400 nanometers.

The second dichroic dye may have a dichroic ratio of about 2 to about 14.

An amount of the second dichroic dye may be about 0.1 to about 10 parts by weight based on 100 parts by weight of the polymer.

The polymer may include a polyolefin, a polyamide, a polyester, a polyacrylate, a polystyrene, a copolymer thereof, or a combination thereof.

The polymer may include polyethylene (PE), polypropylene (PP), polyethylene terephthalate (PET), polyethylene terephthalate glycol (PETG), polyethylene naphthalate (PEN), nylon, a copolymer thereof, or a combination thereof.

According to another embodiment, a polarizing film includes

a polymer,

a first dichroic dye having a maximum absorption wavelength (λₘₐₓ) of about 400 nanometers to about 780 nanometers, and

an ultraviolet (UV) absorber or a second dichroic dye having a maximum absorption wavelength (λₘₐₓ) of about less than 400 nanometers.

The ultraviolet (UV) absorber may have a melting point of about 95 to about 300° C.

The ultraviolet (UV) absorber may include a benzotriazole compound, a triazine compound, a benzoate compound, or a combination thereof.

An amount of the ultraviolet (UV) absorber may be about 0.1 to about 5 parts by weight based on 100 parts by weight of the polymer.

The second dichroic dye may have a maximum absorption wavelength (λₘₐₓ) of about 360 nanometers to about 400 nanometers.

The second dichroic dye may have a dichroic ratio of about 2 to about 14. An amount of the second dichroic dye may be about 0.1 to about 10 parts by weight based on 100 parts by weight of the polymer.

The polymer may include a polyolefin, a polyamide, a polyester, a polyacrylate, a polystyrene, a copolymer thereof, or a combination thereof.

The polymer may include polyethylene (PE), polypropylene (PP), polyethylene terephthalate (PET), polyethylene terephthalate glycol (PETG), polyethylene naphthalate (PEN), nylon, a copolymer thereof, or a combination thereof.

The polarizing film may have transmittance of less than or equal to about 25% at a wavelength of 380 nanometers, and transmittance of greater than or equal to about 40% at a wavelength of about 400 nanometers to about 780 nanometers.

According to another embodiment, a display device including the polarizing film is provided.

### BRIEF DESCRIPTION OF THE DRAWINGS

These and/or other aspects will become apparent and more readily appreciated from the following description of the embodiments, taken in conjunction with the accompanying drawings in which:

FIG. 1 is schematic view of a polarizing film according to an embodiment,

FIG. 2 is a cross-sectional view showing a liquid crystal display (LCD) according to an embodiment, and

FIG. 3 is a cross-sectional view of an organic light emitting diode (OLED) display according to an embodiment.

### DETAILED DESCRIPTION

Exemplary embodiments will hereinafter be described in detail, and may be routinely performed by those who have common knowledge in the related art. However, this disclosure may be embodied in many different forms and is not construed as limited to the exemplary embodiments set forth herein.

Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly in contact with the other element or intervening elements may be present therebetween. In contrast, when an element is referred to as being “directly on” another element, there are no intervening elements present.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, when a definition is not otherwise provided, the term “substituted” refers to a group substituted with at least one substituent selected from a halogen atom (F, Br, Cl, or I), a C1 to C20 alkoxy group, a cyano group, an amino group, a C1 to C20 ester group, a C1 to C20 alkyl group, a C2 to C20 alkenyl group, a C2 to C20 alkynyl group, a C1 to C20 aryl group, a C1 to C20 heteroaryl group, and a combination thereof, instead of hydrogen of a compound.

As used herein, when a definition is not otherwise provided, the term “alkyl” refers to a group derived from a completely saturated, branched or unbranched (or a straight or linear) hydrocarbon. Non-limiting examples of the “alkyl” group include methyl, ethyl, n-propyl, isopropyl, n-butyl, isobutyl, sec-butyl, t-butyl, iso-pentyl, neo-pentyl, iso-amyl, n-hexyl, 3-methylhexyl, 2,2-dimethylpentyl, 2,3-dimethylpentyl, and n-heptyl.

As used herein, when a definition is not otherwise provided, the term “alkoxy” refers to “alkyl-O-”, wherein the term “alkyl” has the same meaning as described above. Non-limiting examples of the alkoxy group are methoxy, ethoxy, propoxy, 2-propoxy, n-butoxy, sec-butoxy, t-butoxy, pentyloxy, hexyloxy, cyclopropoxy, and cyclohexyloxy.

As used herein, when a definition is not otherwise provided, the term “halogen atom” refers to fluorine, bromine, chloride, or iodine.

As used herein, when a definition is not otherwise provided, the term “halogen-containing group” refers to any group including at least one halogen atom.

As used herein, when a definition is not otherwise provided, the term “alkenyl” refers to a group derived from a branched or unbranched hydrocarbon with at least one carbon-carbon double bond. Non-limiting examples of the alkenyl group include vinyl, n-propenyl, n-butenyl, iso-propenyl, and iso-butenyl.

As used herein, when a definition is not otherwise provided, the term “alkynyl” refers to a group derived from a branched or unbranched hydrocarbon with at least one carbon-carbon triple bond. Non-limiting examples of the “alkynyl” group include ethynyl, n-propynyl, n-butynyl, iso-butynyl, and iso-propynyl.

As used herein, when a definition is not otherwise provided, the term “aryl” group, which is used alone or in combination, refers to an aromatic hydrocarbon containing at least one ring. The term “aryl” is construed as including a group with an aromatic ring fused to at least one cycloalkyl ring. Non-limiting examples of the “aryl” group are phenyl, naphthyl, and tetrahydronaphthyl.

As used herein, when a definition is not otherwise provided, the term “heteroaryl” group, which is used alone or in combination, refers to an aryl group, wherein one or more carbon atoms is (are) substituted with a heteroatom selected from nitrogen (N), oxygen (O), phosphorus (P), and sulfur (S). Non-limiting examples of the “heteroaryl” group are pyrrolyl, imidazolyl, pyrazolyl, and pyridyl.

Hereinafter, a composition for a polarizing film according to an embodiment is described.

A composition for a polarizing film includes

a polymer,

a first dichroic dye having a maximum absorption wavelength (λₘₐₓ) of about 400 nanometers (nm) to about 780 nm, and

an ultraviolet (UV) absorber or a second dichroic dye having a maximum absorption wavelength (λₘₐₓ) of about less than 400 nm.

The polymer may be, for example, a hydrophobic polymer, and may be a polyolefin such as polyethylene (PE), polypropylene (PP), a copolymer thereof and a combination thereof; a polyamide such as nylon and an aromatic polyamide; a polyester such as polyethylene terephthalate (PET), polyethylene terephthalate glycol (PETG), and polyethylene naphthalate (PEN); a polyacrylate such as polymethyl (meth)acrylate; a polystyrene such as polystyrene (PS) and an acrylonitrile-styrene copolymer; a polycarbonate; a polyvinyl chloride; a polyimide; a polysulfone; a polyethersulfone; a polyether-etherketone; a polyphenylene sulfide; a polyvinyl alcohol; a polyvinylidene chloride; a polyvinyl butyral; an allylate polymer; a polyoxymethylene; an epoxy polymer; a copolymer thereof; or a combination thereof.

In an embodiment, the polymer may be, for example, polyethylene (PE), polypropylene (PP), polyethylene terephthalate (PET), polyethylene terephthalate glycol (PETG), polyethylene naphthalate (PEN), nylon, a copolymer thereof, or a combination thereof.

The polymer may be, for example, a mixture of at least two polymers selected from polyethylene (PE), polypropylene (PP), and a polyethylene-polypropylene copolymer (PE-PP), and may be, for example, a mixture of polypropylene (PP) and a polyethylene-polypropylene copolymer (PE-PP).

The polypropylene (PP) may have, for example, a melt flow index (MFI) of about 0.1 grams/10 minutes to about 5 grams/10 minutes. Herein, the melt flow index (MFI) shows the mass of a polymer in a melt state flowing per 10 minutes, and relates to viscosity of the polymer in a melted state. In other words, the lower is the melt flow index (MFI), the higher is the viscosity of the polymer, while the higher is the melt flow index (MFI), the lower is the viscosity of the polymer. When the polypropylene (PP) has a melt flow index (MFI) within this range, properties of a final product as well as its workability may be effectively improved. For example, the polypropylene (PP) may have a melt flow index (MFI) ranging from about 0.5 grams 10 minutes to about 5 grams/10 minutes.

The polyethylene-polypropylene copolymer (PE-PP) may include about 1 percent by weight (wt %) to about 50 wt % of an ethylene group based on the total amount of the copolymer. When the polyethylene-polypropylene copolymer (PE-PP) includes the ethylene group within this range, phase separation of the polypropylene and the polyethylene-polypropylene copolymer (PE-PP) may be effectively prevented or suppressed. In addition, the polyethylene-polypropylene copolymer (PE-PP) may have an improved elongation rate during the elongation, excellent light transmittance and alignment, and improved polarization characteristics.

For example, the polyethylene-polypropylene copolymer (PE-PP) may include an ethylene group in an amount of about 1 wt % to about 25 wt % based on the total amount of the copolymer.

The polyethylene-polypropylene copolymer (PE-PP) may have a melt flow index (MFI) ranging from about 5 grams/10 minutes to about 15 grams/10 minutes.

When the polyethylene-polypropylene copolymer (PE-PP) has a melt flow index (MFI) within this range, properties of a final product as well as its workability may be effectively improved. For example, the polyethylene-polypropylene copolymer (PE-PP) may have a melt flow index (MFI) ranging from about 10 grams/10 minutes to about 15 grams/10 minutes.

The polymer may include the polypropylene (PP) and the polyethylene-polypropylene copolymer (PE-PP) in a weight ratio of about 1:9 to about 9:1. When the polypropylene (PP) and the polyethylene-polypropylene copolymer (PE-PP) are included within this range, the polypropylene may be prevented from crystallizing and may have excellent mechanical strength, thus effectively improving its haze characteristics. For example, the polymer may include the polypropylene (PP) and the polyethylene-polypropylene copolymer (PE-PP) in a weight ratio of about 4:6 to about 6:4, and in an embodiment, in a weight ratio of about 5:5.

The polymer may have a melt flow index (MFI) ranging from about 1 grams/10 minutes to about 15 grams/10 minutes. When the polymer has a melt flow index (MFI) within this range, the crystals in the polyolefin are not excessively formed, and the polymer may not only secure excellent light transmittance, but may also have appropriate viscosity for manufacturing a film having improved workability. For example, the polymer may have a melt flow index (MFI) ranging from about 5 grams/10 minutes to about 15 grams/10 minutes.

The polymer may have haze ranging from less than or equal to about 5%. When the polymer has haze within this range, transmittance may be increased, and thus excellent optical properties may be secured. For example, the polymer may have haze of less than or equal to about 2%, and in an embodiment, about 0.5% to about 2%.

The polymer may have crystallinity of less than or equal to about 50%. When the polymer has crystallinity within this range, the polymer may have lower haze and excellent optical properties. For example, the polymer may have crystallinity of about 30% to about 50%.

The polymer may have transmittance of greater than or equal to about 85% in a wavelength region of about 400 nm to about 780 nm. The polymer is elongated in a uniaxial direction. The uniaxial direction may be the length directions of the first and second dichroic dyes.

The first dichroic dye mainly absorbs light in a visible ray region, and its maximum absorption wavelength (λₘₐₓ) is in a visible ray region of about 400 nm to about 780 nm.

The first dichroic dye is dispersed in a polymer and arranged in one direction along the elongation direction of the polymer. The first dichroic dye may transmit one polarizing perpendicular component out of two polarizing perpendicular components in a predetermined wavelength region.

The first dichroic dye may include at least one kind of dye, for example, a dichroic dye absorbing light in one wavelength region out of the first, second, and third wavelength regions differing from one another, or a plurality of dichroic dyes absorbing light in two wavelength regions out of the first, second, and third wavelength regions or light in the first, second, and third wavelength regions. Herein, the first, second, and third wavelength regions may be short, middle, and long wavelength regions, for example, blue, green, and red wavelength regions.

For example, when the first dichroic dye is a plurality of dichroic dyes absorbing light in the red, green, and blue wavelength regions, the plurality of dichroic dyes may be combined to absorb light in all the visible ray regions, that is, a wavelength region ranging from about 400 nm to about 780 nm.

For example, the first dichroic dye may include at least two dichroic dyes having a maximum absorption wavelength of about 400 nm to about 490 nm, at least one dichroic dye having a maximum absorption wavelength of greater than about 490 nm and less than or equal to about 580 nm, and at least one dichroic dye having a maximum absorption wavelength of greater than about 580 nm and less than or equal to about 780 nm. The first dichroic dye may be a yellow dye, a magenta dye, or a cyan dye, but is not limited thereto.

A solubility parameter difference between the first dichroic dye and the polymer may be less than about 7.4. The solubility parameter indicates an interaction degree to which two or more compounds interact. The smaller solubility parameter difference the compounds have, the larger interaction they have, whereas the larger solubility parameter difference the compounds have, the smaller interaction they have.

The solubility parameter has a relation to the structure of a compound. When the polymer and the first dichroic dye have a solubility parameter difference within this range, the polymer and the first dichroic dye have high interaction during the manufacture of a polarizing film, and may increase the melt-mixing property and thus may prevent agglomeration of the dichroic dyes and achieve a uniformly dispersion of the first dichroic dye in the polymer.

A solubility parameter difference between the polymer and the first dichroic dye may be less than or equal to about 7.0, or less than or equal to about 6.7.

The solubility parameter of the polymer may be, for example about 15 to about 18, and in this case, the solubility parameter of the first dichroic dye may be, for example, less than about 24.

The first dichroic dye may have a dichroic ratio of about 2 to about 14 at a maximum absorption wavelength (λₘₐₓ).

The decomposition temperature of the first dichroic dye may be greater than or equal to about 245° C. Herein, the decomposition temperature indicates a temperature at which the weight of the first dichroic dye decreases by about 5% relatively to its initial weight.

The first dichroic dye may be included in an amount of about 0.01 to about 5 parts by weight based on 100 parts by weight of the polymer. Within this range, sufficient polarization characteristics may be obtained without deteriorating transmittance of a polarizing film. Within the above range, the first dichroic dye may be included in an amount of about 0.05 to about 1 part by weight based on 100 parts by weight of the polymer.

The ultraviolet (UV) absorber may absorb ultraviolet (UV) rays, for example, in a wavelength region of less than about 400 nm. The ultraviolet (UV) absorber may have a maximum absorption wavelength (λₘₐₓ) ranging from about 360 to about 400 nm.

When the ultraviolet (UV) absorber is included in the composition for a polarizing film, it may decrease or block light transmittance in an ultraviolet (UV) region through a polarizing film formed of the composition. Accordingly, the ultraviolet (UV) absorber may prevent the ultraviolet (UV) rays from inflowing through the polarizing film from a display panel such as a liquid crystal display panel and/or an organic light emitting display panel during an ultraviolet (UV) exposure process such as an ultraviolet (UV) curing process.

The ultraviolet (UV) absorber may be selected from materials absorbing ultraviolet (UV) rays in the wavelength region but having no influence on polarization characteristics.

For example, the ultraviolet (UV) absorber may have a higher melting point than a temperature of an elongation process of the polarizing film, for example, a melting point of greater than or equal to about 95° C., and in an embodiment, a melting point of about 95 to about 300° C. An ultraviolet (UV) absorber having a melting point within this range may prevent the ultraviolet (UV) absorber from being thermally decomposed during the elongation process of the polarizing film and may have less influence on polarization characteristics of the polarizing film.

The ultraviolet (UV) absorber may include, for example, a benzotriazole compound, a triazine compound, a benzoate compound, or a combination thereof, but is not limited thereto.

The ultraviolet (UV) absorber may be included in an amount of about 0.1 to about 5 parts by weight based on 100 parts by weight of the polymer. Within this range, the ultraviolet (UV) absorber may effectively absorb ultraviolet (UV) rays but have no influence on polarization characteristics of the polarizing film. Within this range, the ultraviolet (UV) absorber may be included in an amount of about 0.1 to 3 parts by weight, and in an embodiment, about 0.3 to 1 parts by weight based on 100 parts by weight of the polymer.

The second dichroic dye is a material transmitting one perpendicular polarizing component out of two perpendicular polarizing components in a predetermined wavelength region and mainly absorbing ultraviolet (UV) rays in a wavelength region of less than about 400 nm. The second dichroic dye may have a maximum absorption wavelength (λₘₐₓ) in a wavelength region of less than about 400 nm, for example, at about 360 to about 400 nm.

When the second dichroic dye is included in the composition for a polarizing film, it may decrease or block light transmittance in an ultraviolet (UV) region through a polarizing film made of the composition. Accordingly, the second dichroic dye may prevent ultraviolet (UV) rays from inflowing through the polarizing film from a display panel such as a liquid crystal display panel and/or an organic light emitting display panel during an ultraviolet (UV) exposure process such as ultraviolet (UV) curing. In addition, the second dichroic dye has no influence on transmittance in a visible ray region, but has polarization characteristics and thus may not deteriorate polarizing efficiency.

The second dichroic dye is dispersed in a polymer and arranged in one direction along the elongation direction of the polymer, like the first dichroic dye. The second dichroic dye may have a dichroic ratio of about 2 to about 14 at a maximum absorption wavelength (Aₘₐₓ).

The second dichroic dye may be included in an amount of about 0.1 to about 10 parts by weight based on 100 parts by weight of the polymer. Within this range, the second dichroic dye may not deteriorate transmittance but may realize sufficient polarization characteristics when used to form a polarizing film. Within this range, the second dichroic dye may be used in an amount of about 0.05 to 8 parts by weight based on 100 parts by weight of the polymer.

The composition for a polarizing film may include at least either one of the ultraviolet (UV) absorber and the second dichroic dye, for example, only the ultraviolet (UV) absorber, only the second dichroic dye, or both the ultraviolet (UV) absorber and the second dichroic dye.

The composition for a polarizing film may include the polymer, the first dichroic dye, the ultraviolet (UV) absorber, and/or the second dichroic dye in a form of a solid such as a powder, respectively. The composition for a polarizing film may have, for example, a solid content of greater than or equal to about 90 wt %, and for example, may not include a solvent.

The polarizing film may be manufactured by melt-blending and elongating the composition for a polarizing film at a temperature of greater than or equal to the melting point (Tm) of the polymer. For example, the polarizing film may be manufactured by a process including melt-blending the composition for a polarizing film to prepare a melt-blend, putting the melt-blend into a mold and pressing it into a sheet, and elongating the sheet in a uniaxial direction.

The melt-blending may be performed at a temperature of less than or equal to about 300° C., and in an embodiment, ranging from about 130 to about 300° C.

The sheet may be formed by putting the melt blend in the mold, and pressing it with a high pressure or discharging it in a chill roll through a T-die.

The elongation in a uniaxial direction may be performed at a temperature ranging from about 25 to about 200° C. at an elongation rate ranging from about 400% to about 1,000%. The elongation rate refers to a length ratio of after the elongation to before the elongation of the sheet, and means the elongation extent of the sheet after uniaxial elongation.

Hereinafter, a polarizing film obtained from the composition for the polarizing film is described referring to drawings.

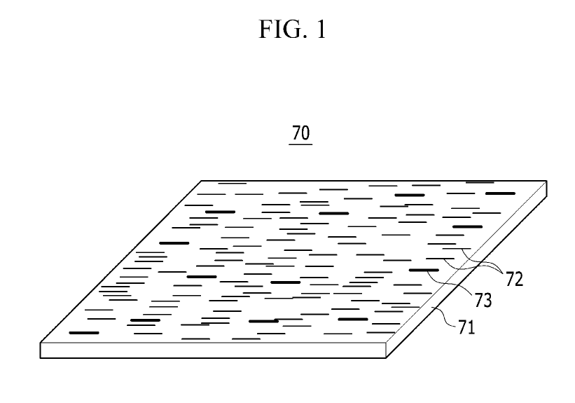

FIG. 1 is a schematic view showing a polarizing film according to an embodiment.

Referring to FIG. 1, a polarizing film 70 according to an embodiment includes a polymer 71, a first dichroic dye 72, and an ultraviolet (UV) absorber (not shown) or a second dichroic dye 73.

The polymer 71 is elongated in a uniaxial direction, which may be the length direction of the first and second dichroic dyes 72 and 73.

The first and second dichroic dyes 72 and 73 and the ultraviolet (UV) absorber are dispersed into the polymer 71, and the first and second dichroic dyes 72 and 73 are aligned in the elongation direction of the polymer 71. The first and second dichroic dyes 72 and 73 are materials that transmit one perpendicular polarization component of two perpendicular polarization components in a predetermined wavelength region.

The polymer 71, first dichroic dye 72, the ultraviolet (UV) absorber, and the second dichroic dye 73 are the same as described above, respectively.

The polarizing film 70 may be a melt-blend of the polymer 71, the first and second dichroic dyes 72 and 73, and the ultraviolet (UV) absorber. The melt-blend may be obtained by melt-blending the above-described composition for a polarizing film at a temperature of greater than or equal to the melting point (Tm) of the polymer 71.

The polarizing film 70 may have a dichroic ratio of about 2 to about 14 at a maximum absorption wavelength (λₘₐₓ) of a visible ray region. Within this range, the dichroic ratio may be about 3 to about 10. Herein, the dichroic ratio may be calculated by dividing plane polarization absorbance in a vertical direction with the axis of a polymer by polarization absorbance in a horizontal direction according to the following Equation 1.

DR=Log(1/T_{⊥}/Log(1/T_{∥}) Equation 1

In Equation 1,

DR denotes a dichroic ratio of a polarizing film,

T_{∥} is light transmittance of light entering parallel to the transmissive axis of a polarizing film, and

T_{⊥} is light transmittance of light entering perpendicular to the transmissive axis of the polarizing film.

The dichroic ratio shows to what degree the first and second dichroic dyes 72 and 73 are arranged in one direction in the polarizing film 70. When the polarizing film 70 has a dichroic ratio within this range in the visible ray wavelength region, the first and second dichroic dyes 72 and 73 are arranged according to the arrangement of polymer chains, improving polarization characteristics of the polarizing film 70.

The polarizing film 70 may have polarization efficiency of greater than or equal to about 80%, and in an embodiment, ranging from about 83% to about 99.9% within this range. Herein, the polarization efficiency may be obtained by the following Equation 2.

PE(%)=[(T_{∥}−T_{⊥})/(T_{∥}−T_{⊥})]^{1/2}×100 Equation 2

In Equation 2,

PE denotes polarization efficiency,

T_{∥} is transmittance of light entering parallel to the transmissive axis of a polarizing film, and

T_{⊥} is transmittance of light entering perpendicular to the transmissive axis of the polarizing film.

The polarizing film 70 may have transmittance of greater than or equal to about 40%, and in an embodiment, ranging from about 42% to about 95% within this range in a visible ray region of about 400 nm to about 780 nm. When the polarizing film 70 having light transmittance within this range is applied to one side of a display device, light emitting from the display device may not be prevented.

The polarizing film 70 may have a relatively thin thickness of less than or equal to about 100 micrometers (μm), for example about 30 μm to about 95 μm. When the polarizing film 70 has a thickness within this range, it may be significantly thinner than a polarizing plate requiring a protective layer such as triacetyl cellulose (TAC) and contribute to realizing a thin display device.

The polarizing film may be applied to various display devices.

The display device may be a liquid crystal display (LCD).

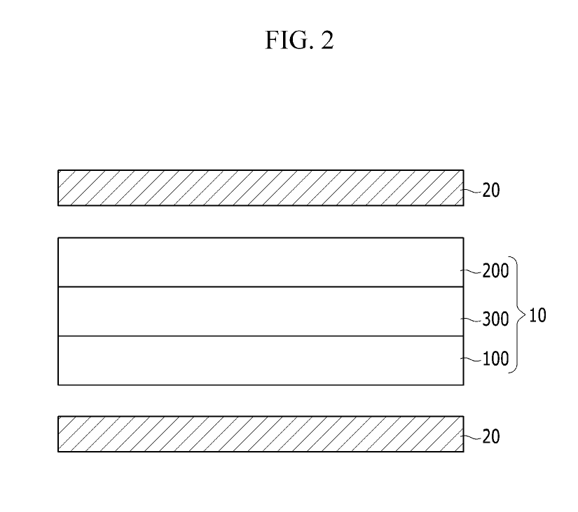

FIG. 2 is a cross-sectional view showing a liquid crystal display (LCD) according to an embodiment.

Referring to FIG. 2, the liquid crystal display (LCD) includes a liquid crystal display panel 10 and a polarizing film 20 disposed on both the lower part and the upper part of the liquid crystal display panel 10.

The liquid crystal display panel 10 may be a twist nematic (TN) mode panel, a patterned vertical alignment (PVA) mode panel, an in-plane switching (IPS) mode panel, an optically compensated bend (OCB) mode panel, and the like.

The liquid crystal display panel 10 includes a first display plate 100, a second display plate 200, and a liquid crystal layer 300 interposed between the first display plate 100 and the second display plate 200.

The first display plate 100 may include, for example, a thin film transistor (not shown) formed on a substrate (not shown), and a first electric field generating electrode (not shown) connected thereto. The second display plate 200 may include, for example, a color filter (not shown) formed on the substrate and a second electric field generating electrode (not shown). However, it is not limited thereto, and the color filter may be included in the first display plate 100, and both the first electric field generating electrode and the second electric field generating electrode may be disposed in the first display plate 100.

The liquid crystal layer 300 may include a plurality of liquid crystal molecules. The liquid crystal molecules may have positive or negative dielectric anisotropy. When the liquid crystal molecules have positive dielectric anisotropy, the long axis thereof may be aligned substantially parallel to the surface of the first display plate 100 and the second display plate 200 when an electric field is not applied, and may be aligned substantially perpendicular to the surface of the first display plate 100 and the second display plate 200 when an electric field is applied. On the contrary, when the liquid crystal molecules have negative dielectric anisotropy, the long axis thereof may be aligned substantially perpendicular to the surface of the first display plate 100 and the second display plate 200 when an electric field is not applied, and may be aligned substantially parallel to the surface of the first display plate 100 and the second display plate 200 when an electric field is applied.

The polarizing film 20 is disposed on the outside of the liquid crystal display panel 10. Although it is shown to be disposed on the upper part and lower part of the liquid crystal display panel 10 in the drawing, it may be formed on either the upper part or the lower part of the liquid crystal display panel 10.

The polarizing film 20 is the same as described above.

The display device may be an organic light emitting diode (OLED) display.

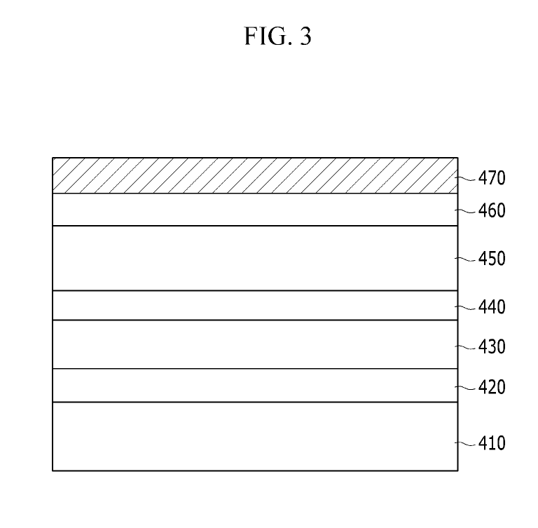

FIG. 3 is a cross-sectional view showing an organic light emitting diode (OLED) display according to an embodiment.

Referring to FIG. 3, an organic light emitting diode (OLED) display according to an embodiment includes a base substrate 410, a lower electrode 420, an organic emission layer 430, an upper electrode 440, an encapsulation substrate 450, a compensation film 460, and a polarizing film 470.

The base substrate 410 may be formed of glass or plastic.

Either of the lower electrode 420 and the upper electrode 440 may be an anode, while the other may be a cathode. The anode is an electrode where holes are injected, and it is formed of a transparent conductive material having a high work function and externally transmitting entered light, for example, ITO or IZO. The cathode is an electrode where electrons are injected, it is formed of a conducting material having a low work function and having no influence on an organic material, and is selected from, for example, aluminum (Al), calcium (Ca), and barium (Ba).

The organic emission layer 430 includes an organic material emitting light when a voltage is applied between the lower electrode 420 and the upper electrode 440.

An auxiliary layer (not shown) may be included between the lower electrode 420 and the organic emission layer 430, and between the upper electrode 440 and the organic emission layer 430. The auxiliary layer may include a hole transport layer for balancing electrons and holes, a hole injection layer (HIL), an electron injection layer (EIL), and an electron transport layer.

The encapsulation substrate 450 may be made of glass, metal, or a polymer. The lower electrode 420, the organic emission layer 430, and the upper electrode 440 are sealed to prevent moisture and/or oxygen from flowing in.

The compensation film 460 may circularly polarize light passing through the polarizing film 470 and generate a phase difference, and thus has an influence on reflection and absorption of the light. The compensation film 460 may be, for example, a phase difference film such as A/4 plate, and may be omitted depending on the case.

The polarizing film 470 may be disposed at a light-emitting side. For example, the polarizing film 470 may be disposed outside of the base substrate 410 in a bottom emission type in which light emits from the base substrate 410, and outside of the encapsulation substrate 450 in a top emission type in which light emits from the encapsulation substrate 450.

The polarizing film 470 is the same as described above.

The compensation film 460 and polarizing film 470 may be disposed at a display screen of an organic light emitting diode (OLED) display and thus may play a role of an antireflective film preventing reflection of light flowing in from the outside. The antireflective film may prevent visibility deterioration due to the light flowing in from the outside.

Hereinafter, the present disclosure is illustrated in more detail with reference to examples. However, these examples are exemplary, and the present disclosure is not limited thereto.

### Example 1

A composition for a polarizing film is prepared by mixing a polymer (a solubility parameter: 16.6) obtained by mixing polypropylene (PP) and a polypropylene-polyethylene copolymer (PP-PE) in a ratio of 5:5 (w/w) with 0.5 parts by weight of three kinds of first dichroic dyes in the following Table 1, and 1 part by weight of a ultraviolet (UV) absorber in Table 2 based on 100 parts by weight of the polymer.

The composition for a polarizing film is melt-blended at about 250° C. with a micro-compounder made by DSM Co. The melt-blend is put in a sheet-shaped mold and pressed at a high temperature with a high pressure, manufacturing a film. Subsequently, the film is 1,000% elongated in a uniaxial direction (a tensile tester made by Instron Inc.) at 115° C., manufacturing a polarizing film.

TABLE 1

| | | | Light | | |
|---|---|---|---|---|---|
| | | | absorp- | | Solu- |
| | | | tion | | bility |
| | | Ratio | range | λmax | para- |
| First dichroic dye | | (%) | (nm) | (nm) | meter |
| Yel- low | 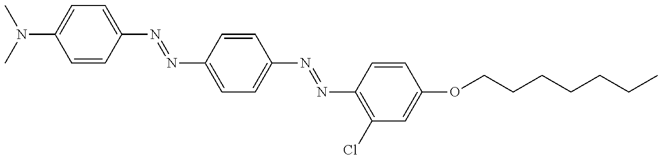 [SMILES: CCCCCCCOc1ccc(/N=N/c2ccc(/N=N/c3ccc(N(C)C)cc3)cc2)c(Cl)c1] | 0.25 | 380- 555 | 455 | 21.7 |
| Red | 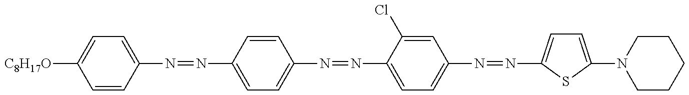 | 0.20 | 380- 700 | 555 | 22.5 |
| Blue | 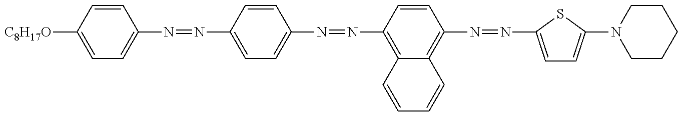 | 0.40 | 380- 780 | 600 | 23.3 |

TABLE 2

| Structure | 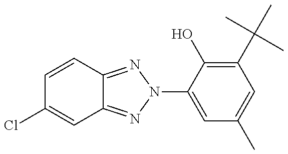 [SMILES: Cc1cc(-n2nc3ccc(Cl)cc3n2)c(O)c(C(C)(C)C)c1] |
|---|---|
| Trade name/Manufacturer | TINUVIN-326/Ciba Chem. |
| Molecular weight | 315.8 g |
| λmax | 349 nm |
| Molar extinction coefficient (@ 380 nm) | 76,324 |
| Solubility parameter | 23.0 |

### Example 2

A polarizing film is manufactured according to the same method as Example 1, except for using 1.0 part by weight of a second dichroic dye in Table 3 instead of the ultraviolet (UV) absorber in Table 2.

TABLE 3

| Structure | 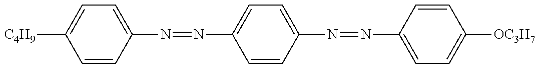 |
|---|---|
| Trade name/Manufacturer | G-207/Hayashibara |
| λmax | 380 nm |
| Dichroic ratio | 6.8 |
| Solubility parameter | 22.0 |

### Example 3

A polarizing film is manufactured according to the same method as Example 1, except for using 0.3 parts by weight of the second dichroic dye in Table 3 instead of 1.0 part by weight of the ultraviolet (UV) absorber in Table 2.

### Example 4

A polarizing film is manufactured according to the same method as Example 1, except for using 0.6 parts by weight of the second dichroic dye in Table 3 along with 1.0 part by weight of the ultraviolet (UV) absorber in Table 2.

### Example 5

A polarizing film is manufactured according to the same method as Example 1, except for using 1.0 part by weight of the second dichroic dye in Table 3 along with 1.0 part by weight of the ultraviolet (UV) absorber in Table 2.

### Example 6

A polarizing film is manufactured according to the same method as Example 1, except for using 2.0 parts by weight of the second dichroic dye in Table 3 along with 1.0 part by weight of the ultraviolet (UV) absorber in Table 2.

### Example 7

A polarizing film is manufactured according to the same method as Example 1, except for using 4.0 parts by weight of the second dichroic dye in Table 3 along with 1.0 part by weight of the ultraviolet (UV) absorber in Table 2.

### Example 8

A polarizing film is manufactured according to the same method as Example 1, except for using 4.0 parts by weight of the second dichroic dye in Table 3 along with 1.0 part by weight of the ultraviolet (UV) absorber in Table 2.

### Example 9

A polarizing film is manufactured according to the same method as Example 1, except for using 2.0 parts by weight of an ultraviolet (UV) absorber in Table 2.

### Example 10

A polarizing film is manufactured according to the same method as Example 1, except for using 3.0 parts by weight of an ultraviolet (UV) absorber in Table 2.

### Example 11

A polarizing film is manufactured according to the same method as Example 1, except for using 4.0 parts by weight of an ultraviolet (UV) absorber in Table 2.

### Comparative Example 1

A polarizing film is manufactured according to the same method as Example 1, except for using no ultraviolet (UV) absorber in Table 2.

### Evaluation

Transmittance and polarizing efficiency of the polarizing film according to Examples 1 to 11 and Comparative Example 1 in the visible ray and ultraviolet (UV) ray regions are evaluated.

The transmittance is obtained by measuring each light transmittance of the polarizing films regarding light entering parallel to a transmittance axis of the polarizing films and regarding light entering perpendicular to the transmittance axis of the polarizing films with a UV-VIS spectrophotometer (V-7100, JASCO).

The transmittance is used to obtain polarizing efficiency (PE).

The polarization efficiency is calculated according to the following Equation 2.

PE(%)=[(T_{∥}−T_{⊥})/(T_{∥}−T_{⊥})]^{1/2}×100 Equation 2

wherein in Equation 2,

PE denotes polarization efficiency,

T_{∥} is transmittance of light entering parallel to the transmissive axis of a polarizing film, and

T_{⊥} is transmittance of light entering perpendicular to the transmissive axis of the polarizing film.

The results are provided in Table 4.

TABLE 4

| | | | Polarization |
|---|---|---|---|
| | Transmittance (%) | Transmittance (%) | efficiency |
| | (@ 400-780 nm) | (@ 380 nm) | (PE, %) |
| Example 1 | 45.0 | 17.0 | 89.9 |
| Example 2 | 45.0 | 27.0 | 90.0 |
| Example 3 | 45.0 | 13.6 | 89.9 |
| Example 4 | 45.1 | 12.8 | 89.8 |
| Example 5 | 45.0 | 11.0 | 90.0 |
| Example 6 | 45.1 | 9.0 | 90.0 |
| Example 7 | 44.9 | 5.8 | 89.9 |
| Example 8 | 44.8 | 3.6 | 90.0 |
| Example 9 | 45.0 | 6.8 | 87.3 |
| Example 10 | 44.9 | 2.7 | 84.7 |
| Example 11 | 45.0 | 1.2 | 83.0 |
| Comparative | 45.0 | 41.8 | 90.2 |
| Example 1 | | | |

Referring to Table 4, the polarizing films according to Examples 1 to 11 have similar visible ray transmittance and polarization efficiency to the polarizing film according to Comparative Example 1, and sharply deteriorated ultraviolet (UV) transmittance in an ultraviolet (UV) wavelength region of 380 nm. For example, the polarizing films according to Examples 1 to 11 show greater than or equal to 40% of transmittance in a visible ray wavelength region ranging from 400 nm to 780 nm, but less than or equal to 25% in a ultraviolet (UV) wavelength region of 380 nm.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A composition for a polarizing film, comprising:
a polymer;
a first dichroic dye having a maximum absorption wavelength (λₘₐₓ) of about 400 nanometers to about 780 nanometers; and
an ultraviolet (UV) absorber or a second dichroic dye having a maximum absorption wavelength (λₘₐₓ) of about less than 400 nanometers.

2. The composition for a polarizing film of claim 1, wherein the ultraviolet (UV) absorber has a melting point of about 95 to about 300° C.

3. The composition for a polarizing film of claim 1, wherein the ultraviolet (UV) absorber comprises a benzotriazole compound, a triazine compound, a benzoate compound, or a combination thereof.

4. The composition for a polarizing film of claim 1, wherein an amount of the ultraviolet (UV) absorber is about 0.1 to about 5 parts by weight based on 100 parts by weight of the polymer.

5. The composition for a polarizing film of claim 1, wherein the second dichroic dye has a maximum absorption wavelength (λₘₐₓ) of about 360 nanometers to about 400 nanometers.

6. The composition for a polarizing film of claim 1, wherein the second dichroic dye has a dichroic ratio of about 2 to about 14 at a maximum absorption wavelength (λₘₐₓ).

7. The composition for a polarizing film of claim 1, wherein an amount of the second dichroic dye is about 0.1 to about 10 parts by weight based on 100 parts by weight of the polymer.

8. The composition for a polarizing film of claim 1, wherein the polymer comprises a polyolefin, a polyamide, a polyester, a polyacrylate, a polystyrene, a copolymer thereof, or a combination thereof.

9. The composition for a polarizing film of claim 8, wherein the polymer comprises polyethylene, polypropylene, polyethylene terephthalate, polyethylene terephthalate glycol, polyethylene naphthalate, nylon, a copolymer thereof, or a combination thereof.

10. A polarizing film, comprising:
a polymer;
a first dichroic dye having a maximum absorption wavelength (λₘₐₓ) of about 400 nanometers to about 780 nanometers; and
an ultraviolet (UV) absorber or a second dichroic dye having a maximum absorption wavelength (λₘₐₓ) of about less than 400 nanometers.

11. The polarizing film of claim 10, wherein the ultraviolet (UV) absorber has a melting point of about 95 to about 300° C.

12. The polarizing film of claim 10, wherein the ultraviolet (UV) absorber comprises a benzotriazole compound, a triazine compound, a benzoate compound, or a combination thereof.

13. The polarizing film of claim 10, wherein an amount of the ultraviolet (UV) absorber is about 0.1 to about 5 parts by weight based on 100 parts by weight of the polymer.

14. The polarizing film of claim 10, wherein the second dichroic dye has a maximum absorption wavelength (λₘₐₓ) of about 360 nanometers to about 400 nanometers.

15. The polarizing film of claim 10, wherein the second dichroic dye has a dichroic ratio of about 2 to about 14.

16. The polarizing film of claim 10, wherein an amount of the second dichroic dye is about 0.1 to about 10 parts by weight based on 100 parts by weight of the polymer.

17. The polarizing film of claim 1, wherein the polymer comprises a polyolefin, a polyamide, a polyester, a polyacrylate, a polystyrene, a copolymer thereof, or a combination thereof.

18. The polarizing film of claim 17, wherein the polymer comprises polyethylene, polypropylene, polyethylene terephthalate, polyethylene terephthalate glycol, polyethylene naphthalate, nylon, a copolymer thereof, or a combination thereof.

19. The polarizing film of claim 10, which has transmittance of less than or equal to about 25% at a wavelength of 380 nanometers, and
transmittance of greater than or equal to about 40% at a wavelength of about 400 nanometers to about 780 nanometers.

20. A display device comprising the polarizing film of claim 10.
